(19) United States
(12) Patent Application Publication
(10) Pub. No.: US 2025/0371409 A1
(43) Pub. Date: Dec. 4, 2025

(54) REDUCING LATENT BIAS IN GENERATIVE MODELS

(71) Applicant: Dell Products L.P., Round Rock, TX (US)

(72) Inventors: OFIR EZRIELEV, Beer Sheva (IL); TOMER KUSHNIR, Omer (IL); AMIHAI SAVIR, Newton, MA (US)

(21) Appl. No.: 18/678,515

(22) Filed: May 30, 2024

(51) Int. Cl. G06N 20/00; G06V 10/84

(52) U.S. Cl. CPC G06N 20/00; G06V 10/84

(57) ABSTRACT

Methods and systems for managing a generative model that may exhibit latent bias are disclosed. To manage the generative model, an output from the generative model may be obtained based on a prompt. A feature identification process may be performed using the output to obtain a set of features. A relationship between the set of the features and the prompt may be compared to bias features of a bias feature repository to obtain a level of latent bias exhibited by the generative model with respect to the prompt. A determination may be made regarding whether the level of latent bias for the generative model meets a latent bias threshold. If the level of latent bias exhibited by the generative model meets the latent bias threshold, an untraining procedure may be performed to obtain a revised generative model, and computer-implemented services may be provided using the revised generative model.

### FIELD

Embodiments disclosed herein relate generally to managing generative models. More particularly, embodiments disclosed herein relate to systems and methods to reduce latent bias in generative models.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a diagram illustrating a data flow in accordance with an embodiment.

FIG. 2B shows a diagram illustrating a neural network in accordance with an embodiment.

FIGS. 2C-2D show diagrams illustrating a multipath neural network in accordance with an embodiment.

FIG. 3 shows a flow diagram illustrating methods of managing a generative model in accordance with an embodiment.

FIGS. 4A-4C show diagrams illustrating data structures and interactions during management of a generative model in accordance with an embodiment.

FIG. 5 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing generative models that may exhibit latent bias and may generate output used in providing computer-implemented services. The latent bias exhibited by the generative models may result in output which does not meet the expectations of a consumer of the output, which may result in negative impacts on the computer-implemented services.

For example, the quality of the computer-implemented services may depend on the quality of the output generated by a generative model. The quality of the output may depend on factors of the training data used to train the generative model, such as the source, type, and/or quantity of the training data. When the factors of the training data exhibit latent bias (e.g., the training data is obtained from a biased source), the output generated by the generative model may also exhibit latent bias. For example, if the training data used to train the generative model exhibits a racial bias feature, the output may also exhibit the racial bias feature. Thus, computer-implemented services which use the output may be of a reduced quality due to the output being influenced by the racial bias feature.

To reduce latent bias in generative models, and thereby improve the quality of output generated by the generative models, features of the output may be identified (e.g., an object and/or subject depicted by the output, characteristics of the object and/or subject). Using a relationship between the features and a prompt used to generate the output, a bias feature may be identified (e.g., a feature not explicitly included in the training data, but that causes the latent bias). Once the bias feature is identified, an untraining procedure may be performed to reduce a level of latent bias exhibited by the generative model (e.g., via a modified split training procedure) to obtain a revised generative model. The revised generative model may then be used to generate output for providing the computer-implemented services.

Thus, embodiments disclosed herein may address, among other technical problems, the technical challenge of reducing latent bias in generative models. Based on an identified bias feature, the generative model may be revised via an untraining procedure to reduce a level of latent bias exhibited by the generative model. The revised generative model may have low predictive power with respect to the bias feature and high predictive power with respect to a target feature (e.g., a desired feature for which the generative model was previously trained to predict). By doing so, output generated by the revised generative model may exhibit a reduced level of latent bias, which may allow the computer-implemented services which use the output to be improved by reducing the influence of the latent bias on the provided services.

In an embodiment, a method for managing a generative model that may exhibit latent bias is disclosed. The method may include: obtaining an output from the generative model, the output being based on a prompt; performing a feature identification process using the output to obtain a set of features from portions of the output that not described as being features in the output; comparing a relationship between the set of the features and the prompt to bias features of a bias feature repository to obtain a level of latent bias exhibited by the generative model with respect to the prompt; making a determination regarding whether the level of latent bias exhibited by the generative model meets a latent bias threshold; in a first instance of the determination in which the level of latent bias exhibited by the generative model meets the latent bias threshold: performing an untraining procedure to reduce the level of latent bias exhibited by the generative model to obtain a revised generative model; and providing computer-implemented services using the revised generative model.

The output may include at least one type of output selected from a group of types of outputs consisting of: text; an image; a video; and audio.

The set of features may include at least one type of feature selected from a group consisting of: a subject depicted by an image; a location depicted by an image; a characteristic of an object depicted in an image; a subject described in text; and an action described in text.

The level of latent bias may indicate a degree of correlation between the relationship and a bias feature of the bias features.

The generative model may be based on a training process using training data including features that are identifiable by a person and labels that do not explicitly relate the bias feature and the labels.

Performing the untraining procedure may include revising the generative model with an incentive against reproduction of the latent bias.

Performing the untraining procedure may include: obtaining, based on the generative model, a multipath generative model including: a first output generation path including a shared body portion and a prediction head portion, the first output generation path including the generative model; and a second output generation path including the shared body portion and a bias feature head portion, the second output generation path being trained to predict the bias feature; performing an untraining process for the second output generation path to reduce the second output generation path's ability to predict the bias feature and to update the shared body portion; performing a training process for the first output generation path while the updated shared body portion is frozen to obtain an updated prediction head portion; and treating the updated prediction head portion and the updated shared body portion as the revised generative model.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

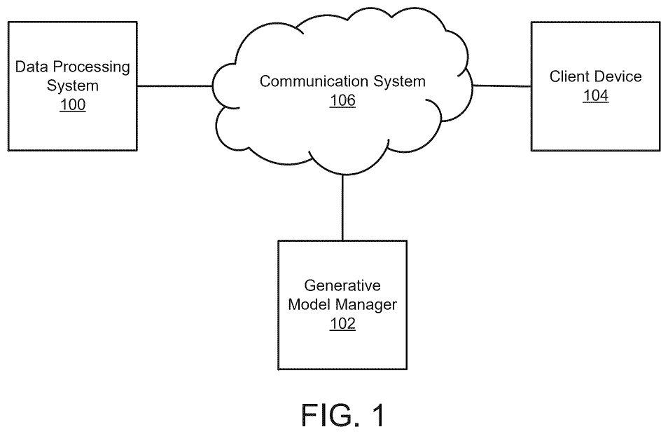

Turning to FIG. 1, a block diagram illustrating a system in accordance with an embodiment is shown. The system shown in FIG. 1 may provide, at least in part, computer-implemented services. The computer-implemented services may include any type and quantity of services including, for example, data services (e.g., data storage, access and/or control services), communication services (e.g., instant messaging services, video-conferencing services), and/or any other type of service that may be implemented with a computing device. The computer-implemented services may be provided by, for example, data processing system 100, generative model manager 102, client device 104, and/or any other type of devices (not shown in FIG. 1). Other types of computer-implemented services may be provided by the system shown in FIG. 1 without departing from embodiments disclosed herein.

The system may include any number and/or type of data processing systems (e.g., 100). Data processing system 100 may host one or more generative models, and any of the computer-implemented services may be provided based on output from the generative models by a consumer of the output (e.g., client device 104). The generative models may, for example, ingest input and generate output based on the ingested input. The content of the input and the output may depend on the goal of the generative model, the architecture of the generative model, and/or other factors.

For example, client device 104 may be a data processing system used by a business to provide employee hiring and recruitment services. A generative model hosted by data processing system 100 may sort through resumes of potential candidates for a job opening, and the output from the generative model (e.g., a ranked list of qualified candidates for the job) may be provided to client device 104. Based on the ranked list of qualified candidates for the job, the business may decide which employees to interview and/or hire for the job opening.

However, if the output from the generative models does not meet expectations of the consumers of the output (e.g., the business), then the computer-implemented services (e.g., employee hiring and recruitment services) may be provided in an undesired manner. For example, the consumers of the output may presume that the output generated by the generative model is of a certain level of quality. If the output fails to meet this level of quality, then the computer-implemented services may be negatively impacted.

The output generated by the generative model may exhibit a low level of quality, for example, if the generative model does not generate output based on input as expected by a manager of the generative model (e.g., generative model manager 102). The relationship between ingested input and output used by the generative model may be established based on training data used to train the generative model. The training data may include labels indicating known relationships between input and output, and the generative model may attempt to generalize the known relationships between the input and output.

However, the process of generalization (e.g., the training process) may result in unforeseen outcomes. For example, the generalization process may result in latent bias being introduced into the generalized relationship used by the generative model to provide output based on input data. Latent bias may be an undesired property of a trained generative model that results in the generative model generating undesirable output (e.g., output not generated as expected by generative model manager 102). For example, training data may include a correlation that is not obvious but that may result in latent bias being introduced into a generative model trained using the training data. If the computer-implemented services are provided based on the output, the inaccurate or otherwise undesirable output may negatively impact the computer-implemented services.

Latent bias may be introduced into generative models based on training data limits and/or other factors. These limits and/or other factors may be based on correlations existing in the training data. For example, the generative model hosted by data processing system 100 may be trained by generative model manager 102 using biased training data. Continuing with the above example, the generative model used to provide the employee hiring and recruitment services may be trained using historical data, such as resumes, for similar job positions. The historical data may include labels indicating which resumes were from hired candidates and which resumes were from rejected candidates.

The generative model may be expected to make generalizations between key words used in successful job applicant resumes and unsuccessful job applicant resumes. However, the historical data (e.g., past resumes) may include not obvious latent bias. For example, the resumes used to train the generative model may have been for job positions in a traditionally male-dominated field (e.g., the tech industry). Based on the historical data, the generative model may identify a relationship between key words used in male candidate resumes (e.g., words identifying the candidate as male in descriptions and/or listing all male schools) with being a more qualified candidate, and a relationship between key words used in female candidate resumes (e.g., words identifying the candidate as female in descriptions and/or listing all female schools) with being a less qualified candidate. Thus, the generative model may be trained to generate output based on a bias feature (e.g., a gender bias feature). The latent bias in the generative model may arise even if the resumes used to train the model are not explicitly labeled to include the gender of the applicant.

Thus, due to the latent bias in the generative model, the correlation between the bias feature and the output from the generative model may lead to undesirable impacts on the computer-implemented services. For example, when used by the business to generate a ranked list of qualified job candidates, the generative model may consistently generate lists indicating female persons are less qualified. This latent bias may cause undesired discrimination against female persons and/or other undesired outcomes when the output is used in providing the computer-implemented services.

In general, embodiments disclosed herein may provide methods, systems, and/or devices for providing generative model management services in a manner that reduces the likelihood of a generative model generating output indicative of a bias feature. As a result, computer-implemented services based on the output may also be more likely to be provided in a manner consistent with a goal of the computer-implemented services.

To provide the generative model management services, a system in accordance with an embodiment may obtain output from a generative model based on a prompt. Features of the output may be identified from portions of the output that are identifiable by a person but may not be described as being features in the output (e.g., objects, locations, and/or people depicted by the output, characteristics of the objects, locations, and/or people). Relationships between the identified features and the prompt may be compared to bias features of a bias feature repository to obtain a level of latent bias exhibited by the generative model with respect to the prompt.

For example, a generative model may be prompted to generate a list of qualified candidates for a job opening. The output may include a list of names, from which gender may be identified as a feature. A relationship between the feature and the prompt may be identified (e.g., the list of qualified candidates includes only traditionally male names). The relationship may be compared to known bias features (e.g., a gender bias feature) from a bias feature repository, which may allow for the identification of latent bias (e.g., based on gender) exhibited by the generative model. The comparison may allow for a level of latent bias to be obtained (e.g., a degree of correlation between gender and being identified by the model as a qualified candidate).

Based on the comparison between the relationship and known bias features, a determination may be made regarding whether the level of latent bias exhibited by the generative model meets a latent bias threshold (e.g., whether the correlation between gender and being identified by the model as a qualified candidate is sufficiently strong). If the level of latent bias meets the latent bias threshold, an untraining procedure may be performed to reduce the level of latent bias exhibited by the generative model to obtain a revised generative model. The untraining procedure may revise the generative model with an incentive against reproduction of the latent bias, which may include generating a multipath generative model and performing a modified split training process. The revised generative model may then be used to provide the computer-implemented services in a manner less likely to generate output based on the bias feature.

By doing so, a system in accordance with an embodiment may increase the likelihood of providing computer-implemented services consistent with the goal of the computer-implemented services (e.g., identifying qualified candidates for a job based on their relevant qualifications) and decrease the likelihood of providing computer-implemented services in a biased manner (e.g., identifying qualified candidates for a job based on their gender).

To perform the above-noted functionality, the system of FIG. 1 may include data processing system 100, generative model manager 102, and/or client device 104. Data processing system 100, generative model manager 102, client device 104, and/or any other type of devices not shown in FIG. 1 may perform all, or a portion of the computer-implemented services independently and/or cooperatively. Each of these components is discussed below.

Client device 104 may be used to provide all, or a portion, of the computer-implemented services. To provide the computer-implemented services, client device 104 may consume output from generative models (e.g., from generative models hosted by data processing system 100). For example, client device 104 may be operated by a user that uses database services, instant messaging services, and/or any other type of services which consume output from a generative model while providing the computer-implemented services.

Data processing system 100 may include any number and/or type of data processing systems, which may host any number of generative models. To perform its functionality, data processing system 100 may (i) obtain prompts (e.g., as input from a user of data processing system 100), (ii) generate output using the generative models based on the prompts, (iii) provide the output to client device 104 and/or generative model manager 102, and/or (iv) perform other tasks related to providing the computer-implemented services.

The generative models hosted by data processing system 100 may be managed by generative model manager 102. To manage the generative models, generative model manager 102 may (i) obtain training data (e.g., from any number of data sources, not shown), (ii) process the training data (e.g., fill data gaps, transform the data, extract values from the data), (iii) perform training procedures to train the generative models, (iv) provide prompts to the generative model, (v) obtain output from the generative models, (vi) identify features of the output, (vii) identify relationships between features of the output and the prompt used to generate the output, (viii) compare the relationships to bias features of a bias feature repository (e.g., in order to identify latent bias exhibited by the generative models), (ix) obtain supplemental information relevant to identifying latent bias exhibited by generative models from any number of sources, (x) perform untraining procedures in order to reduce a level of latent bias exhibited by the generative models to obtain revised generative models, and/or (xi) perform other tasks in order to provide generative model management services.

Thus, generative model management services for data processing system 100 may be provided by generative model manager 102. By doing so, the output generated by a generative model may be monitored and/or tested for the presence of bias features, which may indicate that the generative model is exhibiting a level of latent bias. If latent bias is detected, an untraining procedure may be performed to reduce the level of latent bias, which may result in output that is less likely to be based on a bias feature, which may increase the quality of the computer-implemented services which use the output (e.g., provided by client device 104).

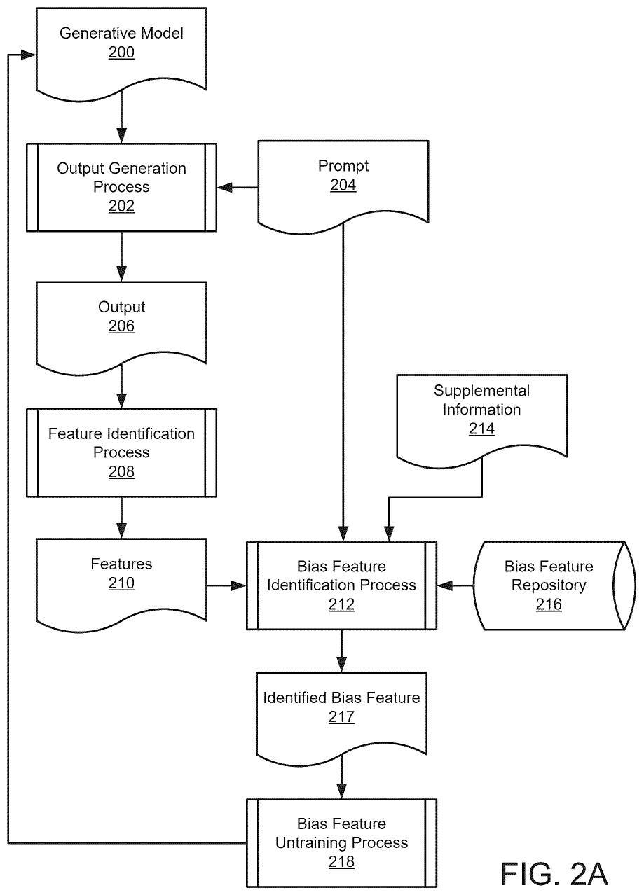

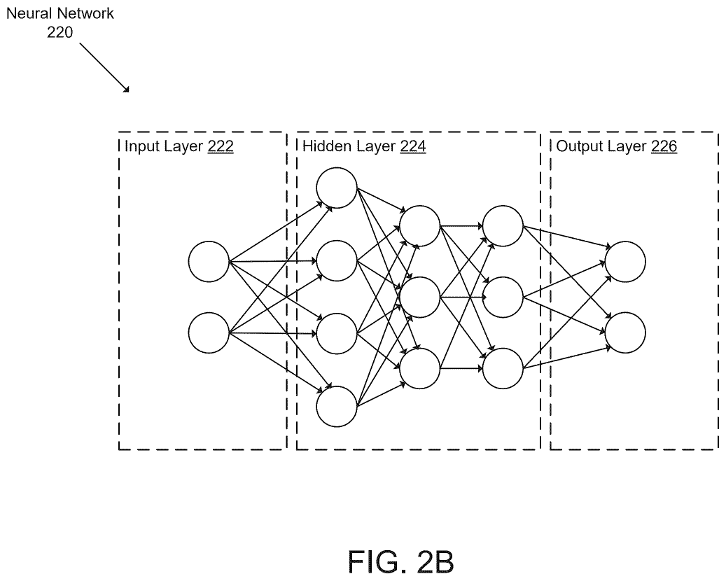

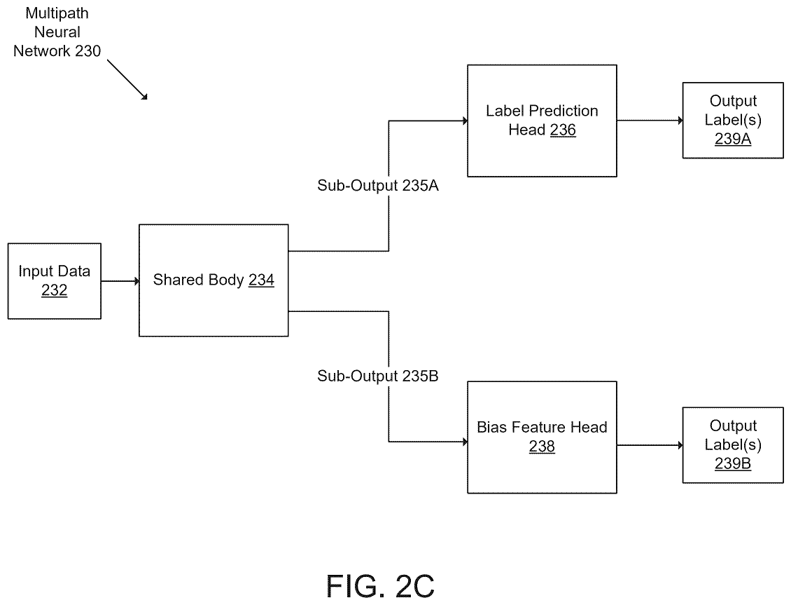

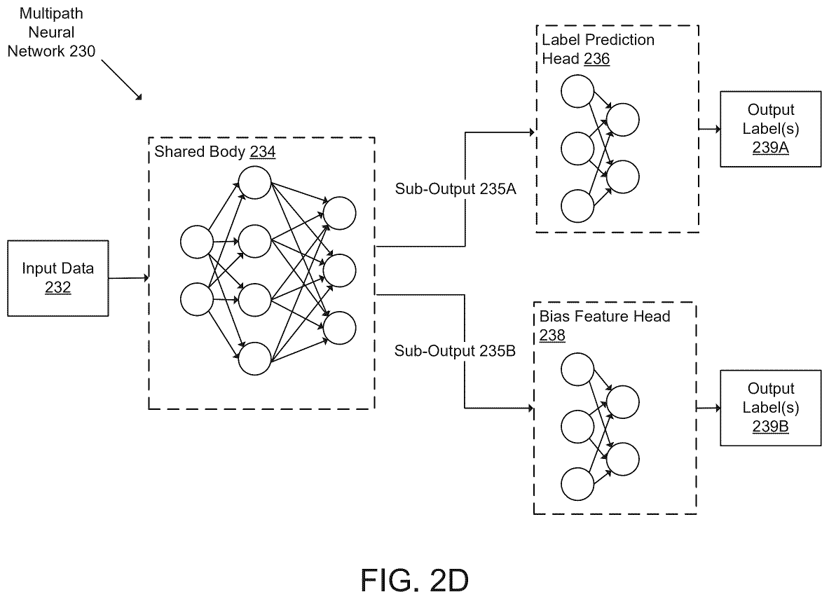

When providing their functionality, data processing system 100, generative model manager 102, and/or client device 104 may perform all, or a portion, of the processes, interactions, and methods illustrated in FIGS. 2A-4C.

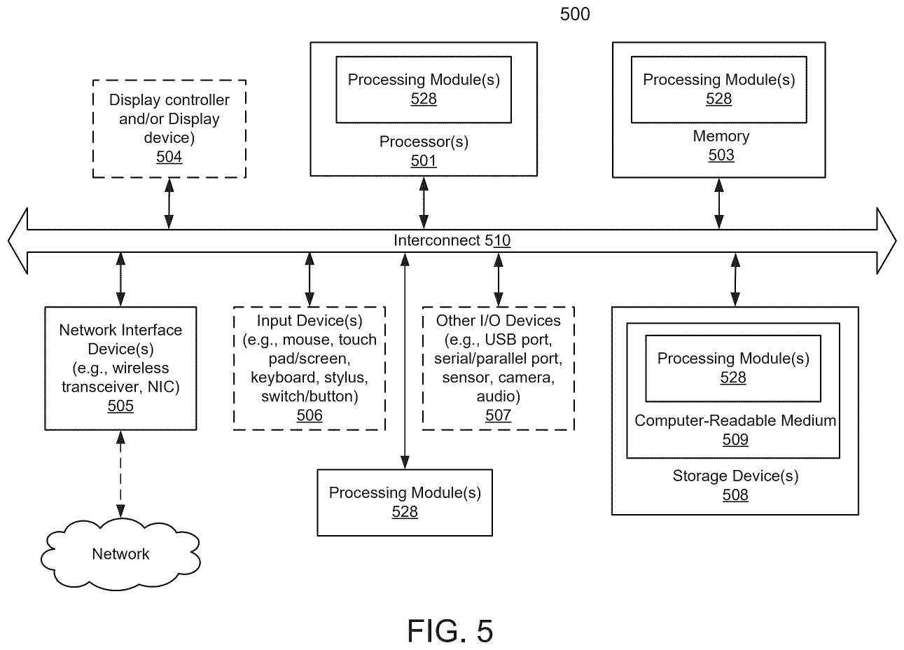

Data processing system 100, generative model manager 102, and/or client device 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), and edge device, an embedded system, local controllers, an edge node, and/or any other type of data processing device or system. For additional details regarding computing devices, refer to FIG. 5.

Any of the components illustrated in FIG. 1 may be operably connected to each other (and/or components not illustrated) with communication system 106. Communication system 106 may facilitate communications between the components of FIG. 1. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein. For example, while the system of FIG. 1 shows a single generative model manager (e.g., 102), it will be appreciated that the system may include any number of generative model managers.

To further clarify embodiments disclosed herein, a data flow diagram in accordance with an embodiment is shown in FIG. 2A. In this diagram, flows of data and processing of data are illustrated using different sets of shapes. A first set of shapes (e.g., 200, 204) is used to represent data structures, a second set of shapes (e.g., 202, 208) is used to represent processes performed using and/or that generate data, and a third set of shapes (e.g., 216) is used to represent large scale data structures such as databases.

Turning to FIG. 2A, a data flow diagram in accordance with an embodiment is shown. The data flow diagram may illustrate data used in and data processing performed in identifying a level of latent bias exhibited by a generative model and performing an untraining procedure to reduce the level of latent bias.

To identify the level of latent bias exhibited by the generative model, output generation process 202 may be performed. During output generation process 202, generative model 200 may be used to generate output 206 based on prompt 204. Generative model 200 may include a neural network that uses a transformer architecture and may generate outputs based on prompts (refer to FIG. 2B-2D for an example of generative model 200). Prompt 204 may include text in human-readable language and/or any other type of input (e.g., an image, a video, audio) which may be used as a guide and/or instructions by generative model 200 to generate output 206. Output 206 may include (i) text, (ii) an image, (iii) a video, (iv) audio, and/or (v) other types of output that may be generated by a generative model. For example, generative model 200 may be used to generate an image (e.g., as output 206) based on prompt 204. Prompt 204 may include, for example, the text “doctor” which may be used by generative model 200 to generate the image.

Once output 206 has been generated, output 206 may be used to perform feature identification process 208. During feature identification process 208, a set of features (e.g., features 210) may be obtained from portions of output 206 (e.g., a subset of pixels in an image) that are identifiable by a person but may not be described as being features in output 206 (e.g., by a large language model (LLM), by an object detection model). Features 210 may include (i) a subject depicted by an image, (ii) a location depicted in an image, (iii) a characteristic of an object depicted in an image, (iv) a subject described in text, (v) an action described in text, and/or (vi) other features of the output.

Continuing with the above example, feature identification process 208 may be performed using the image generated by generative model 200 using the prompt “doctor.” A set of features (e.g., features 210) may be identified using an object detection model, which may use the image as input to identify a subject depicted by the image and characteristics of the subject. The object detection model may identify the image depicts a person, the person wearing a white coat, gloves, and a stethoscope. Other characteristics of the person may also be identified, such as their race (e.g., white) and gender (e.g., male).

Features 210 may be used to perform bias feature identification process 212. During bias feature identification process 212, a relationship between features 210 and prompt 204 may be identified. The relationship may be compared to bias features of a bias feature repository (e.g., bias feature repository 216) to identify a bias feature (e.g., identified bias feature 217). Bias feature repository 216 may include a database of known bias features designated by the entity which oversees generative model 200 (e.g., generative model manager 102), and may include bias features such as race, gender, ethnicity, sexual orientation, etc.

A level of latent bias exhibited by generative model 200 may be obtained (not shown). The level of latent bias may indicate a degree of correlation between the relationship (e.g., between features 210 and prompt 204) and identified bias feature 217 of bias feature repository 216. For example, a stronger correlation between the relationship and identified bias feature 217 may indicate generative model 200 is exhibiting a higher level of latent bias. Levels of latent bias may be represented as numerical values (e.g., a number on a scale of 1-10 with one being a lowest level of latent bias and 10 being a highest level of latent bias), as percentages, may be based on a rubric where labels such as “high” are associated with different bands of the rubric and each band includes a range of degrees of correlation, etc.

Continuing with the above example, a relationship between the features of the image generated and the prompt “doctor” may be identified. The relationship may indicate that generative model 200 strongly correlates gender with the prompt “doctor” (e.g., a high level of latent bias may be exhibited by generative model 200 with respect to a gender bias feature). The level of latent bias may be obtained, for example, by using generative model 200 to generate multiple images with variations of the “doctor” prompt. For example, generative model 200 may be provided prompts including specific types of doctors, such as “dermatologist,” “pediatrician,” “anesthesiologist,” and “family medicine physician” and may generate four images based on the prompts. If all four images are found to depict men, it may be determined that the relationship between gender and output indicates a strong correlation and, therefore, a high level of latent bias. Levels of latent bias may be assigned based on other criteria and/or using other methods without departing from embodiments disclosed herein.

Generative model 200 may be based on a training process using training data including features and labels that do not explicitly relate the bias feature and the labels. Thus, latent bias exhibited by generative model 200 may not be obvious and may arise due to concealed bias in the training data. For example, generative model 200 may be trained to generate images of doctors using training data including images of doctors who work at a hospital. The hospital may, however, have a biased hiring process resulting in the employment of very few female doctors. When generative model 200 is trained to generate images of doctors based on the biased training data, generative model 200 may be more likely to generate images depicting male doctors than female doctors. The resulting gender bias feature in generative model 200 may occur even if the training data does not explicitly include labels indicating the gender of the doctor depicted by the image.

Bias feature identification process 212 may also take into account additional data (e.g., supplemental information 214) that may not be used by generative model 200 during training or to generate output 206. Supplemental information 214 may include any type of additional data which may be used to assist in identifying bias features, including (i) user account information (e.g., data regarding the user of generative model 200 such as location, demographics), (ii) publicly available information (e.g., data relevant to the prompt from sources such as the Internet including forums, social media, and/or public databases), (iii) proprietary information (e.g., data relevant to the prompt owned by the entity overseeing the generative model), and/or (iv) other types of additional data.

For example, generative model 200 may be used by a financial institution to determine loan amounts for clients. The data used by generative model 200 to determine the loan amounts may include information such as credit score, income, number of dependents, location, etc. In order to determine whether generative model 200 is exhibiting a level of latent bias, supplemental information 214 may be used during bias feature identification process 212. Supplemental information 214 may include demographic data of the clients, including data regarding client age, gender, race, etc. which was not used by generative model 200 to generate the loan amounts (e.g., was not provided as input for generative model 200). Using supplemental information 214, it may be determined that there is a correlation between client race and the loan amount generated by generative model 200 (e.g., a racial bias feature).

While identification of the bias feature is described with respect to a single output (e.g., output 206), it will be appreciated that multiple outputs could be used to establish a statistical correlation between the outputs and the bias feature and may be used in obtaining the level of latent bias.

As part of bias feature identification process 212, it may be determined whether the level of latent bias exhibited by generative model 200 with respect to identified bias feature 217 meets a latent bias threshold (not shown). The latent bias threshold may be used to identify whether the degree of correlation between features 210, prompt 204, and identified bias feature 217 is sufficiently strong to warrant revising generative model 200 (e.g., as designated by the entity overseeing generative model 200). While described with respect to making a determination regarding whether to revise generative model 200 based on a level of latent bias and a latent bias threshold, it will be appreciated that other criteria may also be considered while making the determination.

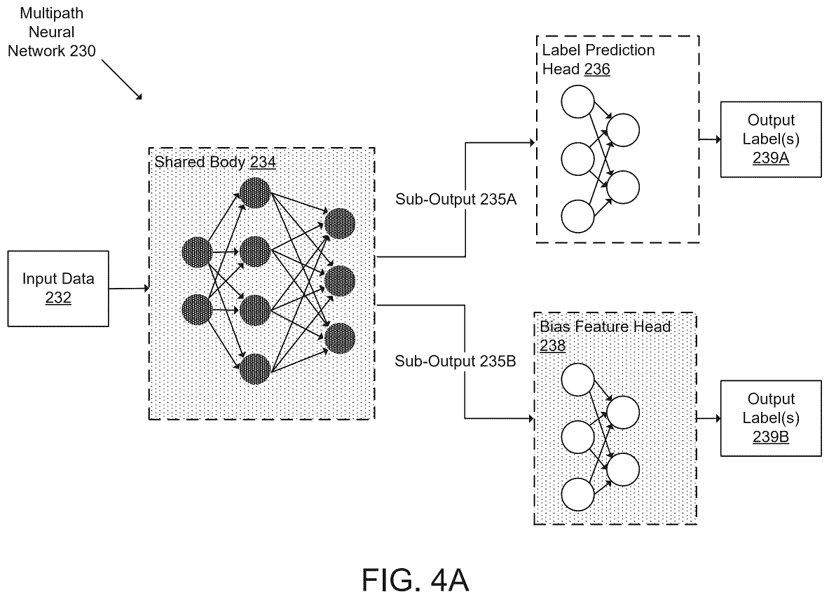

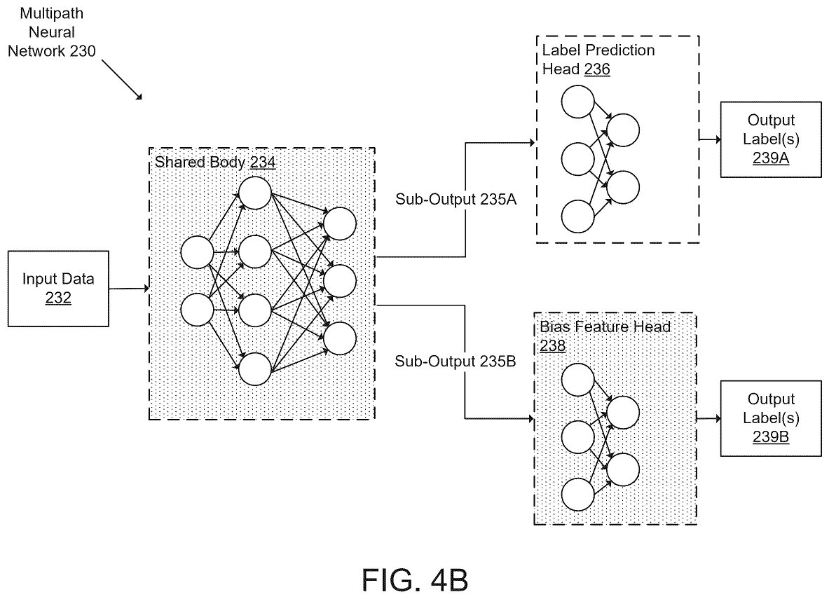

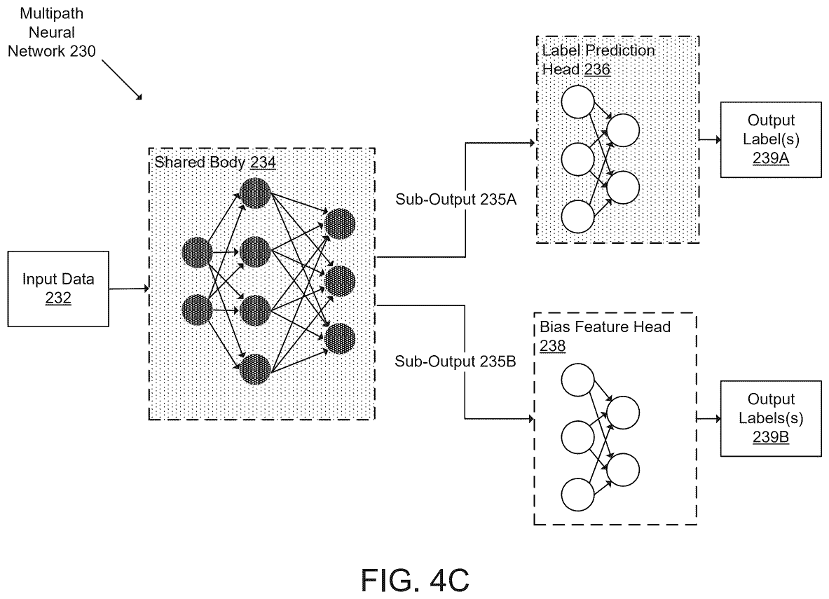

If it is determined that the level of latent bias exhibited by generative model 200 meets the latent bias threshold, bias feature untraining process 218 may be performed to reduce the level of latent bias exhibited by generative model 200. Bias feature untraining process 218 may include revising generative model 200 with an incentive against reproduction of the latent bias to obtain a revised generative model. Refer to FIGS. 2B-2C and FIGS. 4A-4C for additional details regarding an example of bias feature untraining process 218. Generative model 200 may undergo any number of iterations of bias feature identification and/or untraining processes to monitor for and/or reduce a level of latent bias for any number of bias features.

Thus, by implementing the data flow shown in FIG. 2A, a system in accordance with embodiments disclosed herein may obtain a level of latent bias exhibited by a generative model by identifying a relationship between features of the output and a prompt. The relationship may be compared to bias features from a bias feature repository to identify whether a bias feature is present. If a bias feature is identified, an untraining procedure may be performed to reduce the level of latent bias and a revised generative model may be obtained.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

To further clarify embodiments disclosed herein, generative model diagrams in accordance with an embodiment are shown in FIGS. 2B-2D. The generative model diagrams may illustrate a structure of the generative models and/or how data is processed/used within the system of FIG. 1.

Turning to FIG. 2B, a diagram illustrating a neural network (e.g., an implementation of a generative model) in accordance with an embodiment is shown.

In FIG. 2B, neural network 220 may be similar to the generative model hosted by data processing system 100, discussed above. Neural network 220 may include a series of layers of nodes (e.g., neurons, illustrated as circles). This series of layers may include input layer 222, hidden layer 224 (which may include different sub-layers of neurons), and output layer 226. Lines terminating in arrows in this diagram indicate data relationships (e.g., weights). For example, numerical values calculated with respect to each of the neurons during operation of neural network 220 may depend on the values calculated with respect to other neurons linked by the lines (e.g., the weight associated with each line may impact the level of dependence of the value for a second neuron for the value for neuron from which the line initiates). The value calculated with respect to a first neuron may be based, at least in part, on the values of other neurons from which the arrows that terminate in the neuron initiate from.

Each of the layers of neurons of neural network 220 may include any number of neurons and may include any number of sub-layers.

Neural network 220 may exhibit latent bias when trained using training data that includes a bias feature, and/or data that is highly correlated with the bias feature, as discussed above. For example, neural network 220 may be used by a business and may be trained to generate a ranked list of potential candidates for a job opening. Neural network 220 may be trained using training data (e.g., resumes of job applicants) to output the ranked list of potential candidates when prompted. The ranked list of potential candidates may be used by the business to decide which candidates to interview and/or hire for the job opening.

However, depending on the training data and training process, neural network 220 may exhibit latent bias that is based on a correlation in the training data between the lowest ranking suggested by the network and potential candidates who are a part of a protected class (e.g., potential candidates who are of a particular ethnicity, potential candidates who are of a particular gender). Such latent bias may arise even when, for example, neural network 220 does not ingest, as input, any explicit information regarding these characteristics of the potential candidates. In this example, it may be determined that neural network 220 is generating output indicative of latent bias, the latent bias being a correlation between the protected class and the lowest ranking in the output.

To manage presence of bias features, embodiments disclosed herein may provide a system and method that is able to reduce and/or eliminate bias features indicated by output generated by generative models. To do so, the system may modify the architecture of neural network 220. Refer to FIGS. 2C-2D for additional details regarding these modifications to the architecture of neural network 220 to manage bias features.

Turning to FIGS. 2C-2D, diagrams illustrating data structures and interactions within a generative model in accordance with an embodiment are shown.

In FIG. 2C, a diagram of multipath neural network 230 is shown. Multipath neural network 230 may be derived from neural network 220 shown in FIG. 2B. Multipath neural network 230 may be derived by (i) obtaining shared body 234 based on neural network 220 and (ii) adding two heads. The shared body and one head may be members of a first output generation path and the shared body and other head may be members of a second output generation path (it will be appreciated that other output generation paths may be similarly obtained). Input data 232 may be any data to be ingested by multipath neural network 230.

Input data 232 may be ingested by shared body 234. Shared body 234 may include an input layer (e.g., input layer 222 of FIG. 2B) and one or more hidden layers (e.g., a portion of the sub-layers of hidden layer 224 of FIG. 2B).

During operation, shared body 234 may generate intermediate outputs (e.g., sub-output 235A-235B) consumed by the respective heads (e.g., 236, 238) of multipath neural network 230.

Label prediction head 236 may include some number of hidden layers (e.g., that include weights that depend on the values of nodes of shared body 234), and an output layer through which output label(s) 239A are obtained. Similarly, bias feature head 238 may include some number of hidden layers (e.g., that include weights that depend on the values of nodes of shared body 234), and an output layer through which output label(s) 239B are obtained. Output label(s) 239A and 239B may be the output generated based on input data 232 by multipath neural network 230.

A first output generation path may include shared body 234 and label prediction head 236. This first output generation path may, upon ingestion of input data 232, generate output label(s) 239A. The first output generation path may attempt to make predictions as intended by neural network 220.

A second output generation path may include shared body 234 and bias feature head 238. This second output generation path may, upon ingestion of input data 232, generate output label(s) 239B. The second output generation path may attempt to make predictions of an undesired bias feature indicated by predictions made by neural network 220.

Any of shared body 234, label prediction head 236, and bias feature head 238 may include neurons. Refer to FIG. 2D for additional details regarding these neurons.

Turning to FIG. 2D, a diagram illustrating multipath neural network 230 in accordance with an embodiment is shown. As seen in FIG. 2D, shared body 234, label prediction head 236, and bias feature head 238 may each include layers of neurons. Each of shared body 234, label prediction head 236, and bias feature head 238 may include similar or different numbers and arrangements of neurons.

While not illustrated in FIG. 2D, the values for some of the neurons of label prediction head 236 and bias feature head 238 calculated during operation of multipath neural network 230 may depend on the values calculated for some of the neurons of shared body 234. These dependences (i.e., weights) are represented by sub-output 235A and sub-output 235B.

While illustrated in FIGS. 2B-2D as including a limited number of specific components, a neural network and/or multipath neural network may include fewer, additional, and/or different components than those illustrated in these figures without departing from embodiments disclosed herein.

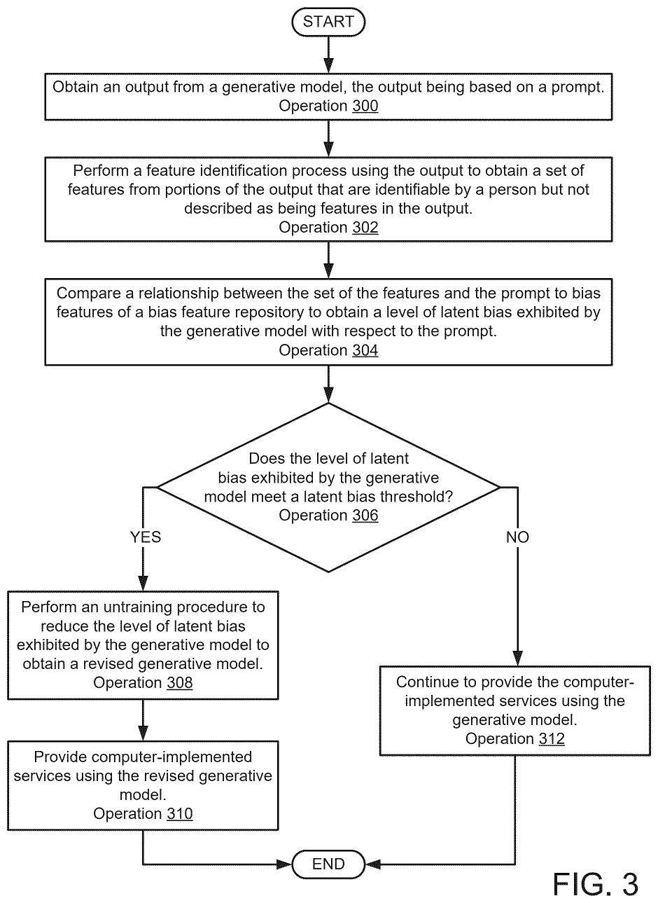

As discussed above, the components of FIGS. 1-2D may perform various methods to manage latent bias in generative models. FIG. 3 illustrates a method that may be performed by the components of the system of FIGS. 1-2D. In the diagram discussed below and shown in FIG. 3, any of the operations may be repeated, performed in different orders, and/or performed in parallel with or in a partially overlapping in time manner with other operations. The method described with respect to FIG. 3 may be performed by a data processing system, any component of a data processing system, and/or another device.

Turning to FIG. 3, a flow diagram illustrating a method of managing a generative model in accordance with an embodiment is shown. The method may be performed, for example, by any of the components of the system of FIG. 1, and/or any other entity without departing from embodiments disclosed herein.

At operation 300, an output from a generative model may be obtained, the output being based on a prompt. Obtaining the output may include (i) generating the output (e.g., training a generative model to generate output using training data, generating the output using the prompt as input) (ii) receiving the output from another entity, (iii) reading the output from storage, and/or (iv) other methods.

At operation 302, a feature identification process may be performed using the output to obtain a set of features from portions of the output that may be identifiable by a person but may not be described as being features in the output. Performing the feature identification process may include (i) identifying features in text using a large language model (LLM) (e.g., identifying a subject described in text, identifying an action described in text), (ii) identifying features in an image using an object detection model (e.g., identifying a subject depicted by an image, identifying a location depicted in an image, identifying a characteristic of an object depicted in an image), and/or (iii) other methods.

For example, performing the feature identification process may include (i) feeding an image from the output into an object detection model, (ii) extracting data from the image (e.g., a color histogram), (iii) using the data to identify groups of pixels which may depict an object, (iv) predicting a label for the object, and/or (v) other methods.

At operation 304, a relationship between the set of the features and the prompt may be compared to bias features of a bias feature repository to obtain a level of latent bias exhibited by the generative model with respect to the prompt. Comparing the relationship to the bias features may include (i) identifying the relationship between the set of the features and the prompt, (ii) obtaining supplemental information relevant to the relationship, (iii) obtaining the bias feature repository, (iv) parsing the bias feature repository to identify bias features correlated with the relationship, (v) selecting a bias feature of the bias feature repository which is correlated with the relationship, (vi) quantifying a degree of correlation between the bias feature and the relationship to obtain a level of latent bias exhibited by the generative model, and/or (vii) other methods.

Identifying the relationship between the set of the features and the prompt may include (i) generating multiple outputs using the prompt and/or variations of the prompt, (ii) identifying a set of features for each of the outputs, (iii) aggregating the sets of features, (iv) determining whether there is a statistical correlation between a feature in the set of features and the prompt, and/or (v) other methods. For example, multiple images may be generated as output using variations of the prompt “attorney.” Features from each of the images may be identified, such as a subject (e.g., a person) and characteristics of the subject (e.g., race, gender). The features may be aggregated to determine whether any of the features (e.g., race) are statistically correlated with the prompt. For example, it may be determined that the majority of images depict a particular race (e.g., white), indicating there may be a statistical correlation between race and the prompt “attorney.”

Quantifying a degree of correlation between the bias feature and the relationship to obtain a level of latent bias may include (i) performing a statistical analysis to calculate the degree of correlation, (ii) assigning the level of latent bias based on the degree of correlation, and/or (iv) other methods. For example, it may be calculated that the generative model produces images depicting individuals of a particular race (e.g., white) 80% of the time when given the prompt “attorney.” The generative model may be assigned a level of latent bias of 8 out of 10 (e.g., on a scale of 1-10 with 1 being the lowest level of latent bias and 10 being the highest level of latent bias). Levels of latent bias may be assigned based on other criteria and/or may be represented in other ways without departing from embodiments disclosed herein.

At operation 306, it may be determined whether the level of latent bias exhibited by the generative model meets a latent bias threshold. Determining whether the level of latent bias meets the latent bias threshold may include (i) obtaining the latent bias threshold (e.g., reading the latent bias threshold from storage, receiving the latent bias threshold from another entity), (ii) comparing a quantity of the level of latent bias to a quantity of the latent bias threshold to determine whether the level of latent bias meets the latent bias threshold, and/or (iii) other methods. Continuing with the above example, a latent bias threshold may be received from an entity responsible for managing the generative model. The latent bias threshold may indicate that latent bias scores at or above 5 (e.g., the quantity of the latent bias threshold) meet the latent bias threshold. The latent bias score of 8 (e.g., the quantity of the level of latent bias) may be compared to the quantity of the latent bias threshold to determine whether the level of latent bias meets the latent bias threshold.

If it is determined that the level of latent bias exhibited by the generative model meets the latent bias threshold (e.g., the determination is “Yes” at operation 306), then the method may proceed to operation 308.

At operation 308, an untraining procedure may be performed to reduce the level of latent bias exhibited by the generative model to obtain a revised generative model. Performing the untraining procedure may include revising the generative model with an incentive against reproduction of the latent bias (e.g., via a modified split training procedure, negative reinforcement learning, a gradient ascent method).

For example, the untraining procedure may be performed via a modified split training procedure. To perform the modified split training procedure, a multipath generative model may be obtained. The multipath generative model may include (i) a first output generation path including a shared body portion and a prediction head portion, and (ii) a second output generation path including the shared body portion and a bias feature head portion. Obtaining the multipath generative model may include: (ii) obtaining a generative model trained using a first training dataset (e.g., reading the generative model from storage, receiving the generative model from another entity, generating the generative model by training the generative model using the first training dataset), (ii) dividing the generative model to obtain a shared body portion and a first head portion (e.g., the prediction head portion), (iii) freezing weights of the shared body portion, (iv) obtaining a second head portion (e.g., the bias feature head portion), (iv) training the bias feature head portion using a second training dataset while the weights of the shared body portion are frozen, and/or (vi) other methods.

An untraining process may be performed for the second output generation path to reduce the second output generation path's ability to predict the bias feature and to update the shared body portion. Performing the untraining process for the second output generation path may include, for example, utilizing a gradient ascent process to increase the inaccuracy and/or reduce the predictive ability of the second output generation path when predicting the bias feature based on the ingest data.

A training process may then be performed for the first output generation path while the updated shared body portion is frozen to obtain an updated prediction head portion. Performing the training process for the first output generation path may include (i) placing the shared body portion weights in an immutable state which may prevent the shared body portion weights from changing values during the training process, (ii) training the first output generation path using training data upon which the original generative model was trained to modify the weights of the prediction head portion (e.g., by performing a global optimization process), and/or (iii) other methods.

The updated prediction head portion and the updated shared body portion may then be treated as the revised generative model. Treating the updated prediction head portion and the updated shared body portion as the revised generative model may include (i) generating output using the updated first output generation path as the revised generative model, (ii) providing the revised generative model to another entity responsible for generating output, and/or (iii) other methods.

Refer to FIGS. 4A-4C for additional details regarding performing the untraining procedure.

At operation 310, computer-implemented services may be provided using the revised generative model. Providing the computer-implemented services may include (i) generating output using the revised generative model based on a prompt, (ii) providing the computer-implemented services based on the output, (iii) providing the output to another entity responsible for providing the computer-implemented services based on the output, and/or (iv) other methods.

The method may end following operation 310.

Returning to operation 306, if it is determined that the level of latent bias exhibited by the generative model does not meet the latent bias threshold (e.g., the determination is “No” at operation 306), then the method may proceed to operation 312.

At operation 312, the computer-implemented services may continue to be provided using the generative model. Continuing to provide the computer-implemented services may include (i) not performing an untraining procedure on the generative model, (ii) generating output using the generative model based on a prompt, (iii) providing the computer-implemented services based on the output, (iv) providing the output to another entity responsible for providing the computer-implemented services based on the output, and/or (v) other methods.

The method may end following operation 312.

Thus, using the methods illustrated in FIG. 3, embodiments disclosed herein may provide systems and methods usable to provide generative model management services in a manner that reduces the likelihood of a generative model generating output indicative of a bias feature. For example, by using modified split training to manage generative models, generative models may be more reliable in providing output that does not lead to discrimination of an individual based on protected class data associated with the individual and/or otherwise including latent bias.

To further clarify embodiments disclosed herein, an example implementation in accordance with an embodiment is shown in FIGS. 4A-4C. These figures show diagrams illustrating data structures and interactions during management of a generative model in accordance with an embodiment. While described with respect to generative model management services, it will be understood that embodiments disclosed herein are broadly applicable to different use cases as well as different types of data processing systems than those described below.

Consider a scenario in which a financial institution offers loans (e.g., of varying amounts) to clients. The financial institution may utilize a generative model (e.g., a neural network) to determine a loan amount to offer each of its clients. The generative model may be trained to ingest input such as mortgage, credit debt, types of purchases, etc. of a client. The generative model may proceed to output a value corresponding to a loan amount to offer the client.

Assume that over time a correlation between low loan amounts and a particular race of the clients (e.g., clients of African American descent) is identified in the output generated by the neural network. To avoid perpetuating discrimination towards clients of the particular race, the financial institution may utilize modified split training to manage the generative model (as discussed previously). This management of the generative model may reduce the likelihood of latent bias being associated with the output generated by the generative model. By doing so, a neural network (similar to neural network 220 of FIG. 2B) may be divided to obtain a multipath generative model (similar to multipath neural network 230 of FIG. 2D).

As shown in FIGS. 4A-4C, once the two output generation paths have been obtained (e.g., a first and a second output generation path as discussed with respect to FIG. 2B-2D), a series of training procedures (as part of the modified split training) may be executed.

Turning to FIG. 4A, a diagram illustrating a first training procedure for the second output generation path of multipath neural network 230 in accordance with an embodiment is shown. The training procedure may set weights of the second output generation path to predict the bias feature (e.g., ingested input that is identified as causing the correlation). This first training procedure is characterized by freezing the weights of the nodes in shared body 234 (illustrated as a dark infill with white dots within the nodes). To perform the first training procedure, the second output generation path may be trained. The portions of multipath neural network 230 trained during the first training procedure are illustrated by a dotted black infill on white background in both shared body 234 and bias feature head 238). Completion of the first training procedure may provide a revised second output generation path in which the bias feature is predicted with high confidence from the revised second output generation path.

Turning to FIG. 4B, a diagram illustrating an untraining procedure for the second output generation path of multipath neural network 230 in accordance with an embodiment is shown. The untraining procedure may set the weights of the second output generation path such that the second output generation path is less able to predict bias features. The untraining procedure may be performed to remove influence of the bias feature on shared body 234. In contrast to FIG. 4A, the weights of shared body 234 that were frozen during the first training procedure may be unfrozen (e.g., graphically illustrated in FIG. 2B by the circular elements representing the nodes being filled with solid white infill) to allow for the values of the weights to change. Completion of this untraining procedure may provide a shared body 234 that includes reduced levels of latent bias for the bias feature. By doing so, the untraining procedure may cause the bias feature to be predicted with reduced confidence.

Turning to FIG. 4C, a diagram illustrating a second training procedure for the first output generation path of multipath neural network 230 in accordance with an embodiment is shown. The second training procedure may set weights for the first output generation path such that the first output generation path is better able to predict desired features (e.g., labels for which an original generative model was trained to predict). Similar to the first training procedure, weights of the nodes of shared body 234 (illustrated as a dark infill with white dots within the nodes) may be frozen while weights of label prediction head 236 may be unfrozen during second training procedure. To perform the second training procedure, the first output generation path may be trained (illustrated by black dotted infill on white background in both shared body 234 and label prediction head 236). Completion of this second training procedure may provide an unbiased generative model (e.g., one that includes reduced levels of latent bias, the unbiased generative model may be based on the first output generation path) to be used in providing computer-implemented services (e.g., generating loan amounts for clients of the financial institution).

Thus, as illustrated in FIGS. 4A-4C, embodiments disclosed herein may facilitate reduction and/or removal of latent bias in generative models used to provide computer-implemented services. By doing so, the computer-implemented services may be provided in a manner that is more likely to meet expectations of consumers of the services.

Any of the components illustrated in FIGS. 1-4C may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing a generative model that may exhibit latent bias, the method comprising:
obtaining an output from the generative model, the output being based on a prompt;
performing a feature identification process using the output to obtain a set of features from portions of the output that not described as being features in the output;
comparing a relationship between the set of the features and the prompt to bias features of a bias feature repository to obtain a level of latent bias exhibited by the generative model with respect to the prompt;
making a determination regarding whether the level of latent bias exhibited by the generative model meets a latent bias threshold;
in a first instance of the determination in which the level of latent bias exhibited by the generative model meets the latent bias threshold:
performing an untraining procedure to reduce the level of latent bias exhibited by the generative model to obtain a revised generative model; and
providing computer-implemented services using the revised generative model.

2. The method of claim 1, wherein the output comprises at least one type of output selected from a group of types of outputs consisting of:
text;
an image;
a video; and
audio.

3. The method of claim 1, wherein the set of features comprises at least one type of feature selected from a group consisting of:
a subject depicted by an image;
a location depicted in an image;
a characteristic of an object depicted in an image;
a subject described in text; and
an action described in text.

4. The method of claim 1, wherein the level of latent bias indicates a degree of correlation between the relationship and a bias feature of the bias features.

5. The method of claim 1, wherein the generative model is based on a training process using training data comprising features that are identifiable by a person and labels that do not explicitly relate the bias feature and the labels.

6. The method of claim 1, wherein performing the untraining procedure comprises revising the generative model with an incentive against reproduction of the latent bias.

7. The method of claim 1, wherein performing the untraining procedure comprises:
obtaining, based on the generative model, a multipath generative model comprising:
a first output generation path comprising a shared body portion and a prediction head portion, the first output generation path comprising the generative model; and
a second output generation path comprising the shared body portion and a bias feature head portion, the second output generation path being trained to predict the bias feature;
performing an untraining process for the second output generation path to reduce the second output generation path's ability to predict the bias feature and to update the shared body portion;
performing a training process for the first output generation path while the updated shared body portion is frozen to obtain an updated prediction head portion; and
treating the updated prediction head portion and the updated shared body portion as the revised generative model.

8. A non-transitory machine-readable medium having instructions stored therein, which when executed by a processor, cause the processor to perform operations for managing a generative model that may exhibit latent bias, the operations comprising:
obtaining an output from the generative model, the output being based on a prompt;
performing a feature identification process using the output to obtain a set of features from portions of the output that are not described as being features in the output;
comparing a relationship between the set of the features and the prompt to bias features of a bias feature repository to obtain a level of latent bias exhibited by the generative model with respect to the prompt;
making a determination regarding whether the level of latent bias exhibited by the generative model meets a latent bias threshold;
in a first instance of the determination in which the level of latent bias exhibited by the generative model meets the latent bias threshold:
performing an untraining procedure to reduce the level of latent bias exhibited by the generative model to obtain a revised generative model; and
providing computer-implemented services using the revised generative model.

9. The non-transitory machine-readable medium of claim 8, wherein the output comprises at least one type of output selected from a group of types of outputs consisting of:
text;
an image;
a video; and
audio.

10. The non-transitory machine-readable medium of claim 8, wherein the set of features comprises at least one type of feature selected from a group consisting of:
a subject depicted by an image;
a location depicted in an image;
a characteristic of an object depicted in an image;
a subject described in text; and
an action described in text.

11. The non-transitory machine-readable medium of claim 8, wherein the level of latent bias indicates a degree of correlation between the relationship and a bias feature of the bias features.

12. The non-transitory machine-readable medium of claim 8, wherein the generative model is based on a training process using training data comprising features that are identifiable by a person and labels that do not explicitly relate the bias feature and the labels.

13. The non-transitory machine-readable medium of claim 8, wherein performing the untraining procedure comprises revising the generative model with an incentive against reproduction of the latent bias.

14. The non-transitory machine-readable medium of claim 8, wherein performing the untraining procedure comprises:
obtaining, based on the generative model, a multipath generative model comprising:
a first output generation path comprising a shared body portion and a prediction head portion, the first output generation path comprising the generative model; and
a second output generation path comprising the shared body portion and a bias feature head portion, the second output generation path being trained to predict the bias feature;
performing an untraining process for the second output generation path to reduce the second output generation path's ability to predict the bias feature and to update the shared body portion;
performing a training process for the first output generation path while the updated shared body portion is frozen to obtain an updated prediction head portion; and
treating the updated prediction head portion and the updated shared body portion as the revised generative model.

15. A data processing system, comprising:
a processor; and
a memory coupled to the processor to store instructions, which when executed by the processor, cause the processor to perform operations for managing a generative model that may exhibit latent bias, the operations comprising:
obtaining an output from the generative model, the output being based on a prompt;
performing a feature identification process using the output to obtain a set of features from portions of the output that are not described as being features in the output;
comparing a relationship between the set of the features and the prompt to bias features of a bias feature repository to obtain a level of latent bias exhibited by the generative model with respect to the prompt;
making a determination regarding whether the level of latent bias exhibited by the generative model meets a latent bias threshold;
in a first instance of the determination in which the level of latent bias exhibited by the generative model meets the latent bias threshold:
performing an untraining procedure to reduce the level of latent bias exhibited by the generative model to obtain a revised generative model; and
providing computer-implemented services using the revised generative model.

16. The data processing system of claim 15, wherein the output comprises at least one type of output selected from a group of types of outputs consisting of:
text;
an image;
a video; and
audio.

17. The data processing system of claim 15, wherein the set of features comprises at least one type of feature selected from a group consisting of:
a subject depicted by an image;
a location depicted in an image;
a characteristic of an object depicted in an image;
a subject described in text; and
an action described in text.

18. The data processing system of claim 15, wherein the level of latent bias indicates a degree of correlation between the relationship and a bias feature of the bias features.

19. The data processing system of claim 15, wherein the generative model is based on a training process using training data comprising features that are identifiable by a person and labels that do not explicitly relate the bias feature and the labels.

20. The data processing system of claim 15, wherein performing the untraining procedure comprises revising the generative model with an incentive against reproduction of the latent bias.
